(19) United States
(12) Patent Application Publication
(10) Pub. No.: US 2002/0028758 A1
(43) Pub. Date: Mar. 7, 2002

(54) Cleaning tablets, and a process for the manufacture of the cleaning tablets

(75) Inventor: Michael Duncan, Northumberland (GB)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(73) Assignee: The Procter & Gamble Company

(21) Appl. No.: 09/893,944

(22) Filed: Jun. 27, 2001

(30) Foreign Application Priority Data
Jun. 27, 2000 (EP) 00202234.1

(51) Int. Cl. C11D 17/06; C11D 17/00

(52) U.S. Cl. 510/446; 510/447

(57) ABSTRACT

The present invention relates to a cleaning tablet comprising active cleaning components such as water-softening builder and/or bleaching agent, the tablet having an external surface, wherein a design is printed onto at least an area of the external surface, and to a process for the manufacture of a cleaning tablet, the cleaning tablet comprising active cleaning components such as water-softening builder and/or bleaching agent, the tablet having an external surface, whereby the process comprises the step of printing a design onto at least an area of the external surface.

### CROSS REFERENCE TO RELATED APPLICATIONS

This application claims priority under 35 U.S.C. § 119(a) to European Application No. 00202234.1, filed Jun. 27, 2000.

The present invention relates to cleaning tablets, and to a process for the manufacture of the cleaning tablets.

Cleaning tablets are commercially available for various purposes, for example: laundry washing, conditioning and bleaching; dish washing; denture cleaning; hard surface cleaning; toilet bowl cleaning and freshening. Cleaning tablets for these and other purposes will vary greatly in chemical composition, but all comprise some active cleaning components such as water-softening builder and/or bleaching agents.

Many of the known cleaning tablets are made by compressing a particulate or granular base powder in a tabletting mold. Some tablets may be given some degree of distinctiveness by means of colored particles of granules in the base powder which may give a speckled or layered appearance. Many cleaning tablets, however, are partly or predominantly white, because this has connotations of cleaning for the consumer. Hence the known cleaning tablets lack distinctiveness.

The present invention provides distinctiveness to a cleaning tablet by means of a design printed on to the external surface of the tablet.

The printing of designs onto the outer surface of an object is well-known in the food industry. Designs are printed onto food items such as eggs, fruit, chocolate and confectionery. Furthermore designs are commonly printed onto tablets in the pharmaceutical industry in order to enable the customer to identify the correct tablet, as well as possibly aiding the customer with other information, such as the correct dosage. In both of these applications important considerations are that the printing ink should be indelible (i.e. it should not easily wash off, or rub off), and furthermore that it is safe for the customer to ingest. Typically such inks must meet requirements of regulatory agencies such as the Federal Drugs Administration.

### SUMMARY OF THE INVENTION

The present invention relates to a cleaning tablet comprising active cleaning components such as water-softening builder and/or bleaching agent, the tablet having an external surface, wherein a design is printed onto at least an area of the external surface, and to a process for the manufacture of a cleaning tablet, the cleaning tablet comprising active cleaning components such as water-softening builder and/or bleaching agent, the tablet having an external surface, whereby the process comprises the step of printing a design onto at least an area of the external surface.

### DETAILED DESCRIPTION OF THE INVENTION

An important consideration for the printing inks of the present invention is that they should not transfer to the object which is being cleaned (i.e. the fabrics, dishes, dentures, toilet bowl etc.) Other considerations for the selection of the printing inks of the present invention are: human safety; compatibility with the surface to which the ink is applied; speed of drying of the ink (preferably less than one minute); high solubility in water; good stability over time without colour bleeding or fading.

The printing can be achieved by one of the following preferred printing methods.

Ink-jet printing

The ink-jet printing technology can be used in the two different technologies drop on demand and continuous ink-jet as described below.

High pressure ink is sent to a special cannon with a jet nozzle. This cannon contains a piezoelectric device (resonator) which transmits acoustic vibration to the jet which causes it to break up into droplets. Each second, up to 100,000 drops are generated. They all have the same size, determined by the diameter of the nozzle, usually about 70 micrometers.

A ring-shaped charge electrode is placed around the jet at the break-off point. When a droll leaves the jet, it carries a charge proportional to the voltage applied to it.

The series of drops then passes between two deflection plates between which a high constant difference in electrical potential is maintained. The drops are thus deflected from their initial trajectory proportionately to their electrical charge. Any uncharged drops are recuperated and recycled in the ink reservoir.

The combination of the drop deflection and of the object movement perpendicular to this deflection enables writing of all kinds of patterns, notably characters, on any substrate regardless of its nature.

A variation from the continuous jet as described above is known as “binary printing”.

The basic principle of binary printing is similar to that of normal ink jet printing, tiny drops of ink are deflected in flight by an electrostatic field. It differs from normal ink jet in the use of the voltage on the print drop and the subsequent deflection of that drop. With binary printing, an array of several individual jets of ink is used (currently around 5.2 jets per mm, or 132 jets per 1 inch print width). The charge electrode applies a charge to the ink drop which is deflected, when no charge is applied the drop is not deflected. The ink drops that are not used for printing are charged and are deflected into the gutter. The uncharged drops are not deflected by the high voltage field and fall onto the substrate for printing. Because uncharged drops are used for printing optimum print quality and speed can be achieved.

The drop on demand (DOD) printing technique is much simpler than the continuous ink jet system, but offers lower performances in terms of quality and marking speed.

Printers based on this principle have one (or several) print head(s) equipped with exhaust valves (or nozzles) whose size determines the size of the drops. For each dot to be printed, a low pressure drop is projected from the corresponding valve.

As the valves are electronically controlled, they open and close very fast, releasing a drop “on demand” according to the character to be printed.

The printing speed of both printing methods (continuous and drop on demand) can range up to 100 m/min. The resolution of the printed image may be up to 360 dpi (14.2 dots per mm) or higher with future technology improvements. A high number (up to 32 millions) of image colors can be achieved with using 3 print heads and mixing the colors of the print with the basic colors, either in the RGB (Red Green Blue) system or in the YMC (Yellow Magenta Cyan) system. The print-heads need to be synchronized to achieve a good picture quality. The size of the printed image can range from 1 mm² to images of 50×50 mm. Coverage of the printed object ranges up to 100%.

The composition of the printing inks of the present invention varies according on the type of printing technology used.

Typical inks for use in continuous ink jet processes comprise about 60% by weight of solvents and oils, such as glycerols, about 16% by weight of polymers, about 10% by weight of dyes and pigments and about 14% by eight of surfactants.

Typical inks for use in drop on demand processes comprise about 60% by weight of solvents and oils, such as MEK solvents), up to 5% by weight of polymers, from about 6% to about 15% by weight of dyes and pigments, and optionally low levels of surfactants.

The most suitable inks for printing onto cleaning tablets have a viscosity between about 3 centiPoise and about 12 centipoise, a surface tension of at least 25 dynes/cm, a conductivity of from about 500 to about 1000 μS/cm, and solids, when present having a maximum particle size of less than about 1 micrometer.

Preferred inks for use in continuous ink jet printing have a viscosity between about 3 centipoise and about 8 centipoise and a surface tension of from about 25 to about 40 dynes/cm.

Preferred inks for use in drop on demand printing have a viscosity between about 8 centipoise and about 12 centipoise and a surface tension greater than about 32 dynes/cm.

These physical properties are measurable using commonly known techniques in the temperature range between 15 degrees C. and 50 degrees C.

Offset Printing

Another printing method that can be used to achieve the tablet appearance is offset printing. This printing method is well known today. The ink is applied to a primary cylinder which holds the desired image to be printed. The ink is then transferred via a secondary cylinder (mostly a rubber type of material) to the object to be printed.

Printing speed and resolution can be much higher than in ink-jet printing. The colors have to be mixed here as well from the three basic colors, either Red/Green/Blue or Yellow/Magenta/Cyan.

The size of the printed image can range from 1 mm² to images of 50×50 mm. Coverage of the printed object ranges up to 100%.

Laser printing

The word “Laser” is an acronym for “Light Amplification by Stimulated Emission of Radiation”. Lasers produce coherent, monochromatic radiation that is capable of delivering large amounts of energy in a small area.

There are many kinds of lasers. As example, some laser printers use state-of-the-art sealed CO₂ lasers to deliver efficient and flexible operation.

The basic operation principle of those sealed carbon dioxide lasers is simple. Carbon dioxide gas is contained in a sealed tube mounted with mirrors at either end. When the gas is excited externally by RF energy, its molecules absorb energy. When they reach a point of “Spontaneous Emission”, a photon is emitted. The photon is amplified as it stimulates more photon emissions while it moves along the tube. The photons bounce along the tube between one mirror which is fully reflective and the other which is partially transmissive. When a critical mass is reached, a pulse of heat radiation is emitted to form the laser beam. The laser light is then focused via lenses to produce precise marking energy.

Unlike other traditional coding and marking technologies, laser has no tooling that can wear over time. Once the operating parameters are set correctly, the laser system will apply codes consistently onto the products or packages.

Laser produces marks by permanently changing the surface of substrates. Depending on the substrate, the laser beam can vaporize the surface material (ink on paper or card stock), cause a distinct surface change (glass and PET) or react chemically to change the color of the substrate (some plastics or materials with thermal coatings). The result is a crisp, indelible image that cannot be removed or altered. Laser systems use no consumable such as inks and solvents. The only element touching the product is controlled laser light.

For high speed printing, a high speed dot matrix coder is commonly used. A group of several, small high-power laser tubes are placed inside the print head. Each of the lasers produces power of over 30 watts. When stimulated by RF energy, the lasers are fired individually to produce a vertical column of seven separate dots at one time. The system relies on the movement of the surface to build these lines into dot matrix characters.

The operation is simple and fully variable without any moving parts. It is also very fast because of the high power output.

For high resolution, a high resolution scribing laser is commonly used. These printers are often powered by a single 25-watt sealed CO₂ laser and can code onto both static and moving products. They incorporate a pair of moving mirrors whose motion combines to direct the laser beam to make a continuous mark much like that from a pen. The mark is fully variable and high quality. The mirrors are controlled by galvanometer assemblies and can achieve high speeds.

Most preferred components of the cleaning tablets are surfactants, builders, bleach, bleach activator, polymers, enzymes, perfumes. More details of preferred tablet compositions, including specific examples are disclosed in EP-A-0 846 754, EP-A-0 846 755 and EP-A-0 846 756, published on Jun. 10, 1996. Nonlimiting examples of surfactants useful herein typically at levels from about 1% to about 55%, by weight, include the conventional C₁₁₋C₁₈ alkyl benzene sulfonates (“LAS”) and primary, branched-chain and random C₁₀₋C₂₀ alkyl sulfates (“AS”), the C₁₀₋C₁₈ secondary (2,3) alkyl sulfates of the formula CH₃(CH₂)ₓ(CHOSO₃₋M⁺) CH₃ and CH₃ (CH₂)_{y}(CHOSO₃₋M⁺) CH₂CH₃ where x and (y+1) are integers of at least about 7, preferably at least about 9, and M is a water-solubilizing cation, especially sodium, unsaturated sulfates such as oleyl sulfate, the C₁₀₋C₁₈ alkyl alkoxy sulfates (“AE_{X}S”; especially EO 1-7 ethoxy sulfates), C₁₀₋C₁₈ alkyl alkoxy carboxylates (especially the EO 1-5 ethoxycarboxylates), the C₁₀₋₁₈ glycerol ethers, the C₁₀₋C₁₈ alkyl polyglycosides and their corresponding sulfated polyglycosides, and C₁₂₋C₁₈ alpha-sulfonated fatty acid esters. If desired, the conventional nonionic and amphoteric surfactants such as the C₁₂₋C₁₈ alkyl ethoxylates (“AE”) including the so-called narrow peaked alkyl ethoxylates and C₆-C₁₂ alkyl phenol alkoxylates (especially ethoxylates and mixed ethoxy/propoxy), C₁₂₋C₁₈ betaines and sulfobetaines (“sultaines”), C₁₀₋C₁₈ amine oxides, and the like, can also be included in the overall compositions. The C₁₀-C₁₈ N-alkyl polyhydroxy fatty acid amides can also be used. Typical examples include the C₁₂-C₁₈ N-methylglucamides. See WO 9,206,154. Other sugar-derived surfactants include the N-alkoxy polyhydroxy fatty acid amides, such as C₁₀-C₁₈ N-(3-methoxypropyl) glucamide. The N-propyl through N-hexyl C₁₂-C₁₈ glucamides can be used for low sudsing. C₁₀-C₂₀ conventional soaps may also be used. If high sudsing is desired, the branched-chain C₁₀-C₁₆ soaps may be used. Mixtures of anionic and nonionic surfactants are especially useful. Other conventional useful surfactants are listed in standard texts. In a preferred embodiment, the tablet comprises at least 5% per weight of surfactant, more preferably at least 15% per weight, even more preferably at least 25% per weight, and most preferably between 35% and 45% per weight of surfactant.

Non Gelling Binders

Non gelling binders can be integrated in detergent compositions to further facilitate dissolution. If non gelling binders are used, suitable non-gelling binders include synthetic organic polymers such as polyethylene glycols, polyvinylpyrrolidones, polyacrylates and water-soluble acrylate copolymers. The handbook of Pharmaceutical Excipients second edition, has the following binders classification: Acacia, Alginic Acid, Carbomer, Carboxymethylcellulose sodium, Dextrin, Ethylcellulose, Gelatin, Guar gum, Hydrogenated vegetable oil type I, Hydroxyethyl cellulose, Hydroxypropyl methylcellulose, Liquid glucose, Magnesium aluminum silicate, Maltodextrin, Methylcellulose, polymethacrylates, povidone, sodium alginate, starch and zein. Most preferable binders also have an active cleaning function in the laundry wash such as cationic polymers, i.e. ethoxylated hexamethylene diamine quaternary compounds, bishexamethylene triamines, or others such as pentaamines, ethoxylated polyethylene amines, maleic acrylic polymers.

Non-gelling binder materials are preferably sprayed on and hence have an appropriate melting point temperature below 90° C., preferably below 70° C. and even more preferably below 50° C. so as not to damage or degrade the other active ingredients in the matrix. Most preferred are non-aqueous liquid binders (i.e. not in aqueous solution) which may be sprayed in molten form. However, they may also be solid binders incorporated into the matrix by dry addition but which have binding properties within the tablet.

Non-gelling binder materials are preferably used in an amount within the range from 0.1 to 15% of the composition, more preferably below 5% and especially if it is a non laundry active material below 2% by weight of the tablet.

It is preferred that gelling binders, such as nonionic surfactants are avoided in their liquid or molten form. Nonionic surfactants and other gelling binders are not excluded from the compositions, but it is preferred that they be processed into the detergent tablets as components of particulate materials, and not as liquids.

Builders

Detergent builders can optionally be included in the compositions herein to assist in controlling mineral hardness. Inorganic as well as organic builders can be used. Builders are typically used in fabric laundering compositions to assist in the removal of particulate soils.

The level of builder can vary widely depending upon the end use of the composition. Inorganic or P-containing detergent builders include, but are not limited to, the alkali metal, ammonium and alkanolammonium salts of polyphosphates (exemplified by the tripolyphosphates, pyrophosphates, and glassy polymeric meta-phosphates), phosphonates, phytic acid, silicates, carbonates (including bicarbonates and sesquicarbonates), sulphates, and aluminosilicates. However, non-phosphate builders are required in some locales. Importantly, the compositions herein function surprisingly well even in the presence of the so-called “weak” builders (as compared with phosphates) such as citrate, or in the so-called “underbuilt” situation that may occur with zeolite or layered silicate builders.

Examples of silicate builders are the alkali metal silicates, particularly those having a SiO₂:Na₂O ratio in the range 1.6:1 to 3.2:1 and layered silicates, such as the layered sodium silicates described in U.S. Pat. No. 4,664,839, issued May 12, 1987 to H. P. Rieck. NaSKS-6 is the trademark for a crystalline layered silicate marketed by Hoechst (commonly abbreviated herein as “SKS-6”). Unlike zeolite builders, the Na SKS-6 silicate builder does not contain aluminum. NaSKS-6 has the delta-Na₂SiO₅ morphology form of layered silicate. It can be prepared by methods such as those described in German DE-A-3,417,649 and DE-A-3,742,043. SKS-6 is a highly preferred layered silicate for use herein, but other such layered silicates, such as those having the general formula NaMSiₓO₂ₓ₊₁.yH₂O wherein M is sodium or hydrogen, x is a number from 1.9 to 4, preferably 2, and y is a number from 0 to 20, preferably 0 can be used herein. Various other layered silicates from Hoechst include NaSKS-5, NaSKS-7 and NaSKS-11, as the alpha, beta and gamma forms. As noted above, the delta-Na₂SiO₅ (NaSKS-6 form) is most preferred for use herein. Other silicates may also be useful such as for example magnesium silicate, which can serve as a crispening agent in granular formulations, as a stabilizing agent for oxygen bleaches, and as a component of suds control systems.

Examples of carbonate builders are the alkaline earth and alkali metal carbonates as disclosed in German Patent Application No. 2,321,001 published on Nov. 15, 1973.

Aluminosilicate builders are useful in the present invention. Aluminosilicate builders are of great importance in most currently marketed heavy duty granular detergent compositions, and can also be a significant builder ingredient in liquid detergent formulations. Aluminosilicate builders include those having the empirical formula:

M_{z}(zAlO₂)_{y}].xH₂O

wherein z and y are integers of at least 6, the molar ratio of z to y is in the range from 1.0 to about 0.5, and x is an integer from about 15 to about 264.

Useful aluminosilicate ion exchange materials are commercially available. These aluminosilicates can be crystalline or amorphous in structure and can be naturally-occurring aluminosilicates or synthetically derived. A method for producing aluminosilicate ion exchange materials is disclosed in U.S. Pat. No. 3,985,669, Krummel, et al, issued Oct. 12, 1976. Preferred synthetic crystalline aluminosilicate ion exchange materials useful herein are available under the designations Zeolite A, Zeolite P (B), Zeolite MAP and Zeolite X. In an especially preferred embodiment, the crystalline aluminosilicate ion exchange material has the formula:

Na₁₂[(AlO₂)₁₂(SiO₂)₁₂].xH₂O

wherein x is from about 20 to about 30, especially about 27. This material is known as Zeolite A. Dehydrated zeolites (x=0-10) may also be used herein. Preferably, the aluminosilicate has a particle size of about 0.1-10 microns in diameter.

Organic detergent builders suitable for the purposes of the present invention include, but are not restricted to, a wide variety of polycarboxylate compounds. As used herein, “polycarboxylate” refers to compounds having a plurality of carboxylate groups, preferably at least 3 carboxylates. Polycarboxylate builder can generally be added to the composition in acid form, but can also be added in the form of a neutralized salt. When utilized in salt form, alkali metals, such as sodium, potassium, and lithium, or alkanolammonium salts are preferred.

Included among the polycarboxylate builders are a variety of categories of useful materials. One important category of polycarboxylate builders encompasses the ether polycarboxylates, including oxydisuccinate, as disclosed in Berg, U.S. Pat. No. 3,128,287, issued Apr. 7, 1964, and Lamberti et al, U.S. Pat. No. 3,635,830, issued Jan. 18, 1972. See also “TMS/TDS” builders of U.S. Pat. No. 4,663,071, issued to Bush et al, on May 5, 1987. Suitable ether polycarboxylates also include cyclic compounds, particularly alicyclic compounds, such as those described in U.S. Pat. Nos. 3,923,679; 3,835,163; 4,158,635; 4,120,874 and 4,102,903.

Other useful detergency builders include the ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Citrate builders, e.g., citric acid and soluble salts thereof (particularly sodium salt), are polycarboxylate builders of particular importance for heavy duty liquid detergent formulations due to their availability from renewable resources and their biodegradability. Citrates can also be used in granular compositions, especially in combination with zeolite and/or layered silicate builders. Oxydisuccinates are also especially useful in such compositions and combinations.

Also suitable in the detergent compositions of the present invention are the 3,3-dicarboxy-4-oxa-1,6-hexanedioates and the related compounds disclosed in U.S. Pat. No. 4,566,984, Bush, issued Jan. 28, 1986. Useful succinic acid builders include the C₅-C₂₀ alkyl and alkenyl succinic acids and salts thereof. A particularly preferred compound of this type is dodecenylsuccinic acid. Specific examples of succinate builders include: laurylsuccinate, myristylsuccinate, palmitylsuccinate, 2-dodecenylsuccinate (preferred), 2-pentadecenylsuccinate, and the like. Laurylsuccinates are the preferred builders of this group, and are described in European Patent Application 86200690.5/0,200,263, published Nov. 5, 1986.

Other suitable polycarboxylates are disclosed in U.S. Pat. No. 4,144,226, Crutchfield et al, issued Mar. 13, 1979 and in U.S. Pat. No. 3,308,067, Diehl, issued Mar. 7, 1967. See also Diehl U.S. Pat. No. 3,723,322.

Fatty acids, e.g., C₁₂-C₁₈ monocarboxylic acids, can also be incorporated into the compositions alone, or in combination with the aforesaid builders, especially citrate and/or the succinate builders, to provide additional builder activity. Such use of fatty acids will generally result in a diminution of sudsing, which should be taken into account by the formulator.

In situations where phosphorus-based builders can be used, and especially in the formulation of bars used for hand-laundering operations, the various alkali metal phosphates such as the well-known sodium tripolyphosphates, sodium pyrophosphate and sodium orthophosphate can be used. Phosphonate builders such as ethane-1-hydroxy-1,1-diphosphonate and other known phosphonates (see, for example, U.S. Pat. Nos. 3,159,581; 3,213,030; 3,422,021; 3,400,148 and 3,422,137) can also be used.

Bleach

The detergent compositions herein may optionally contain bleaching agents or bleaching compositions containing a bleaching agent and one or more bleach activators. When present, bleaching agents will typically be at levels of from about 1% to about 30%, more typically from about 5% to about 20%, of the detergent composition, especially for fabric laundering. If present, the amount of bleach activators will typically be from about 0.1% to about 60%, more typically from about 0.5% to about 40% of the bleaching composition comprising the bleaching agent-plus-bleach activator.

The bleaching agents used herein can be any of the bleaching agents useful for detergent compositions in textile cleaning, hard surface cleaning, or other cleaning purposes that are now known or become known. These include oxygen bleaches as well as other bleaching agents. Perborate bleaches, e.g., sodium perborate (e.g., mono- or tetra-hydrate) can be used herein.

Another category of bleaching agent that can be used without restriction encompasses percarboxylic acid bleaching agents and salts thereof. Suitable examples of this class of agents include magnesium monoperoxyphthalate hexahydrate, the magnesium salt of metachloro perbenzoic acid, 4-nonylamino-4-oxoperoxybutyric acid and diperoxydodecanedioic acid. Such bleaching agents are disclosed in U.S. Pat. No. 4,483,781, Hartman, issued Nov. 20, 1984, U.S. patent application 740,446, Bums et al, filed Jun. 3, 1985, European Patent Application 0,133,354, Banks et al, published Feb. 20, 1985, and U.S. Pat. No. 4,412,934, Chung et al, issued Nov. 1, 1983. Highly preferred bleaching agents also include 6-nonylamino-6-oxoperoxycaproic acid as described in U.S. Pat. No. 4,634,551, issued Jan. 6, 1987 to Burns et al.

Peroxygen bleaching agents can also be used. Suitable peroxygen bleaching compounds include sodium carbonate peroxyhydrate and equivalent “percarbonate” bleaches, sodium pyrophosphate peroxyhydrate, urea peroxyhydrate, and sodium peroxide. Persulfate bleach (e.g., OXONE, manufactured commercially by DuPont) can also be used.

A preferred percarbonate bleach comprises dry particles having an average particle size in the range from about 500 micrometers to about 1,000 micrometers, not more than about 10% by weight of said particles being smaller than about 200 micrometers and not more than about 10% by weight of said particles being larger than about 1,250 micrometers. Optionally, the percarbonate can be coated with silicate, borate or water-soluble surfactants. Percarbonate is available from various commercial sources such as FMC, Solvay and Tokai Denka.

Mixtures of bleaching agents can also be used.

Peroxygen bleaching agents, the perborates, the percarbonates, etc., are preferably combined with bleach activators, which lead to the in situ production in aqueous solution (i.e., during the washing process) of the peroxy acid corresponding to the bleach activator. Various nonlimiting examples of activators are disclosed in U.S. Pat. No. 4,915,854, issued Apr. 10, 1990 to Mao et al, and U.S. Pat. No. 4,412,934. The nonanoyloxybenzene sulfonate (NOBS) and tetraacetyl ethylene diamine (TAED) activators are typical, and mixtures thereof can also be used. See also U.S. Pat. No. 4,634,551 for other typical bleaches and activators useful herein.

Highly preferred amido-derived bleach activators are those of the formulae:

R¹N(R⁵)C(O)R²C(O)L or R¹C(O)N(R⁵)R²C(O)L

wherein R¹ is an alkyl group containing from about 6 to about 12 carbon atoms, R² is an alkylene containing from 1 to about 6 carbon atoms, R⁵ is H or alkyl, aryl, or alkaryl containing from about 1 to about 10 carbon atoms, and L is any suitable leaving group. A leaving group is any group that is displaced from the bleach activator as a consequence of the nucleophilic attack on the bleach activator by the perhydrolysis anion. A preferred leaving group is phenyl sulfonate.

Preferred examples of bleach activators of the above formulae include (6-octanamido-caproyl)oxybenzenesulfonate, (6-nonanamidocaproyl)oxybenzenesulfonate, (6-decanamido-caproyl)oxybenzenesulfonate, and mixtures thereof as described in U.S. Pat. No. 4,634,551, incorporated herein by reference.

Another class of bleach activators comprises the benzoxazin-type activators disclosed by Hodge et al in U.S. Pat. No. 4,966,723, issued Oct. 30, 1990, incorporated herein by reference. A highly preferred activator of the benzoxazin-type is:

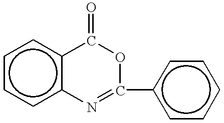

Still another class of preferred bleach activators includes the acyl lactam activators, especially acyl caprolactams and acyl valerolactams of the formulae:

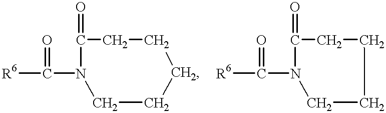

wherein R⁶ is H or an alkyl, aryl, alkoxyaryl, or alkaryl group containing from 1 to about 12 carbon atoms. Highly preferred lactam activators include benzoyl caprolactam, octanoyl caprolactam, 3,5,5-trimethylhexanoyl caprolactam, nonanoyl caprolactam, decanoyl caprolactam, undecenoyl caprolactam, benzoyl valerolactam, octanoyl valerolactam, decanoyl valerolactam, undecenoyl valerolactam, nonanoyl valerolactam, 3,5,5-trimethylhexanoyl valerolactam and mixtures thereof. See also U.S. Pat. No. 4,545,784, issued to Sanderson, Oct. 8, 1985, incorporated herein by reference, which discloses acyl caprolactams, including benzoyl caprolactam, adsorbed into sodium perborate.

Bleaching agents other than oxygen bleaching agents are also known in the art and can be utilized herein. One type of non-oxygen bleaching agent of particular interest includes photoactivated bleaching agents such as the sulfonated zinc and/or aluminum phthalocyanines. See U.S. Pat. No. 4,033,718, issued Jul. 5, 1977 to Holcombe et al. If used, detergent compositions will typically contain from about 0.025% to about 1.25%, by weight, of such bleaches, especially sulfonate zinc phthalocyanine.

If desired, the bleaching compounds can be catalyzed by means of a manganese compound. Such compounds are well known in the art and include, for example, the manganese-based catalysts disclosed in U.S. Pat. No. 5,246,621, U.S. Pat. No. 5,244,594; U.S. Pat. No. 5,194,416; U.S. Pat. No. 5,114,606; and European Pat. App. Pub. Nos. 549,271A1, 549,272A1, 544,440A2, and 544,490A1; Preferred examples of these catalysts include Mn^{IV}₂(u-O)₃(1,4,7-trimethyl-1,4,7-triazacyclo-nonane)₂(PF₆)₂, Mn^{III}₂(u-O)₁(u-OAc)₂(1,4,7-trimethyl-1,4,7-triazacyclononane)₂₋(ClO₄)₂, Mn^{IV}₄(u-O)₆(1,4,7-triazacyclononane)₄(ClO₄)₄, Mn^{III}Mn^{IV}₄(u-O)₁(u-OAc)₂₋(1,4,7-trimethyl-1,4,7-triazacyclononane)₂(ClO₄)₃, Mn^{IV}(1,4,7-trimethyl-1,4,7-triazacyclononane)-(OCH₃)₃(PF₆), and mixtures thereof. Other metal-based bleach catalysts include those disclosed in U.S. Pat. No. 4,430,243 and U.S. Pat. No. 5,114,611. The use of manganese with various complex ligands to enhance bleaching is also reported in the following U.S. Pat. Nos. 4,728,455; 5,284,944; 5,246,612; 5,256,779; 5,280,117; 5,274,147; 5,153,161; and 5,227,084.

As a practical matter, and not by way of limitation, the compositions and processes herein can be adjusted to provide on the order of at least one part per ten million of the active bleach catalyst species in the aqueous washing liquor, and will preferably provide from about 0.1 ppm to about 700 ppm, more preferably from about 1 ppm to about 500 ppm, of the catalyst species in the laundry liquor.

Enzymes

Enzymes can be included in the formulations herein for a wide variety of fabric laundering purposes, including removal of protein-based, carbohydrate-based, or triglyceride-based stains, for example, and for the prevention of refugee dye transfer, and for fabric restoration. The enzymes to be incorporated include proteases, amylases, lipases, cellulases, and peroxidases, as well as mixtures thereof. Other types of enzymes may also be included. They may be of any suitable origin, such as vegetable, animal, bacterial, fungal and yeast origin. However, their choice is governed by several factors such as pH-activity and/or stability optima, thermostability, stability versus active detergents, builders and so on. In this respect bacterial or fungal enzymes are preferred, such as bacterial amylases and proteases, and fungal cellulases.

Enzymes are normally incorporated at levels sufficient to provide up to about 5 mg by weight, more typically about 0.01 mg to about 3 mg, of active enzyme per gram of the composition. Stated otherwise, the compositions herein will typically comprise from about 0.001% to about 5%, preferably 0.01%-1% by weight of a commercial enzyme preparation. Protease enzymes are usually present in such commercial preparations at levels sufficient to provide from 0.005 to 0.1 Anson units (AU) of activity per gram of composition.

Suitable examples of proteases are the subtilisins which are obtained from particular strains of B. subtilis and B. licheniforms. Another suitable protease is obtained from a strain of Bacillus, having maximum activity throughout the pH range of 8-12, developed and sold by Novo Industries A/S under the registered trade name ESPERASE. The preparation of this enzyme and analogous enzymes is described in British Patent Specification No. 1,243,784 of Novo. Proteolytic enzymes suitable for removing protein-based stains that are commercially available include those sold under the tradenames ALCALASE and SAVINASE by Novo Industries A/S (Denmark) and MAXATASE by International Bio-Synthetics, Inc. (The Netherlands). Other proteases include Protease A (see European Patent Application 130,756, published Jan. 9, 1985) and Protease B (see European Patent Application Serial No. 87303761.8, filed Apr. 28, 1987, and European Patent Application 130,756, Bott et al, published Jan. 9, 1985).

Amylases include, for example, α-amylases described in British Patent Specification No. 1,296,839 (Novo), RAPIDASE, International Bio-Synthetics, Inc. and TERMAMYL, Novo Industries.

The cellulase usable in the present invention include both bacterial or fungal cellulase. Preferably, they will have a pH optimum of between 5 and 9.5. Suitable cellulases are disclosed in U.S. Pat. No. 4,435,307, Barbesgoard et al, issued Mar. 6, 1984, which discloses fungal cellulase produced from Humicola insolens and Humicola strain DSM1800 or a cellulase 212-producing fungus belonging to the genus Aeromonas, and cellulase extracted from the hepatopancreas of a marine mollusk (Dolabella Auricula Solander). suitable cellulases are also disclosed in GB-A-2.075.028; GB-A-2.095.275 and DE-OS-2.247.832. CAREZYME (Novo) is especially useful.

Suitable lipase enzymes for detergent usage include those produced by microorganisms of the Pseudomonas group, such as Pseudomonas stutzeri ATCC 19.154, as disclosed in British Patent 1,372,034. See also lipases in Japanese Patent Application 53,20487, laid open to public inspection on Feb. 24, 1978. This lipase is available from Amano Pharmaceutical Co. Ltd., Nagoya, Japan, under the trade name Lipase P “Amano,” hereinafter referred to as “Amano-P.” Other commercial lipases include Amano-CES, lipases ex Chromobacter viscosum, e.g. Chromobacter viscosum var. lipolyticum NRRLB 3673, commercially available from Toyo Jozo Co., Tagata, Japan; and further Chromobacter viscosum lipases from U.S. Biochemical Corp., U.S.A. and Disoynth Co., The Netherlands, and lipases ex Pseudomonas gladioli. The LIPOLASE enzyme derived from Humicola lanuginosa and commercially available from Novo (see also EPO 341,947) is a preferred lipase for use herein.

Peroxidase enzymes are used in combination with oxygen sources, e.g., percarbonate, perborate, persulfate, hydrogen peroxide, etc. They are used for “solution bleaching,” i.e. to prevent transfer of dyes or pigments removed from substrates during wash operations to other substrates in the wash solution. Peroxidase enzymes are known in the art, and include, for example, horseradish peroxidase, ligninase, and haloperoxidase such as chloro- and bromo-peroxidase. Peroxidase-containing detergent compositions are disclosed, for example, in PCT International Application WO 89/099813, published Oct. 19, 1989, by O. Kirk, assigned to Novo Industries A/S.

A wide range of enzyme materials and means for their incorporation into synthetic detergent compositions are also disclosed in U.S. Pat. No. 3,553,139, issued Jan. 5, 1971 to McCarty et al. Enzymes are further disclosed in U.S. Pat. No. 4,101,457, Place et al, issued Jul. 18, 1978, and in U.S. Pat. No. 4,507,219, Hughes, issued Mar. 26, 1985, both. Enzyme materials useful for liquid detergent formulations, and their incorporation into such formulations, are disclosed in U.S. Pat. No. 4,261,868, Hora et al, issued Apr. 14, 1981. Enzymes for use in detergents can be stabilized by various techniques. Enzyme stabilization techniques are disclosed and exemplified in U.S. Pat. No. 3,600,319, issued August 17, 1971 to Gedge, et al, and European Patent Application Publication No. 0 199 405, Application No. 86200586.5, published Oct. 29, 1986, Venegas. Enzyme stabilization systems are also described, for example, in U.S. Pat. No. 3,519,570.

Other components which are commonly used in detergent compositions and which may be incorporated into detergent tablets include chelating agents, soil release agents, soil antiredeposition agents, dispersing agents, suds suppressors, fabric softeners, dye transfer inhibition agents and perfumes.

Preferred coating materials may be either soluble or insoluble, the insoluble dicarboxylic acids disclosed in EP-A-0 846 754, EP-A-0 846 755 and EP-A-0 846 756 being particularly preferred. Most preferred coating materials are sebacic acid and adipic acid.

Below is an example of blue ink composition for application on laundry cleaning tablets.

### EXAMPLE

| | |
|---|---|
| Ethanol | 60% |
| Sandolan blue E-HRL 180 | 10% |
| PEG 200 | 30% |

The preferred process for the manufacture of the tablets according to the present invention is by ink-jet printing, offset printing or by gravure printing (laser printing).

A commercially available laundry detergent powder, Ariel Ultra, manufactured by Procter & Gamble is compressed at a pressure of 140 N/cm² in a square mold (41 mm×41 mm) to form a tablet. The tablet is coated with adipic acid by dipping the tablet into a coating bath.

The surface of the tablets are printed using an ink-jet printer, dynamically at a speed between 20 m/min and 90 m/min. The logo, comprising the brand name and trade mark, applied has the following properties; resolution: 180 dpi (7.1 dots per mm), 40×40 mm, volume of ink: 7.2×10⁻⁶ liters/logo.

What is claimed is:

1. A cleaning tablet comprising active cleaning components such as water-softening builder and bleaching agent, the tablet having an external surface, characterized in that a design is printed onto at least an area of the external surface.

2. A cleaning tablet according to claim 1, wherein the active cleaning components comprise a water-insoluble builder, which is sodium aluminosilicate.

3. A cleaning tablet according to claim 1, wherein the active cleaning components comprise a water-soluble builder which is phosphate.

4. A cleaning tablet according to claim 1, the tablet being suitable for cleaning laundry, and further comprising a surfactant selected from the group consisting of anionic surfactant, nonionic surfactant, and mixtures thereof.

5. A cleaning tablet according to claim 1, wherein the external surface is formed by a surface coating, at least in the area of the coated external surface onto which the design is printed.

6. A cleaning tablet according to claim 5, wherein the surface coating material is water-insoluble.

7. A cleaning tablet according to claim 1, wherein the printed design is a trademark or logo.

8. A process for the manufacture of a cleaning tablet, the cleaning tablet comprising active cleaning components such as water-softening builder and bleaching agent, the tablet having an external surface, characterized by the step of printing a design onto at least an area of the external surface.

9. A process according to claim 8, wherein the step of printing is selected from ink-jet printing, offset printing and laser printing.

10. A process according either to claim 8, wherein the cleaning tablet is provided with an surface coating on at least a part of the external surface, and subsequently the design is printed onto the surface coating.

11. A process according to claim 10, wherein the step of providing the surface coating is selected from shower coating and dipping the tablet into a coating bath.
